(19) United States
(12) Patent Application Publication
(10) Pub. No.: US 2011/0317624 A1
(43) Pub. Date: Dec. 29, 2011

(54) METHODS OF CONTROL/DATA PARTITION SCHEME IN HETEROGENEOUS NETWORKS FOR LTE-A

(75) Inventors: Tao Luo, San Diego, CA (US); Juan Montojo, San Diego, CA (US); Taesang Yoo, San Diego, CA (US)

(73) Assignee: QUALCOMM INCORPORATED, San Diego, CA (US)

(21) Appl. No.: 13/166,436

(22) Filed: Jun. 22, 2011

Related U.S. Application Data
(60) Provisional application No. 61/357,878, filed on Jun. 23, 2010.

(51) Int. Cl. H04W 4/00

(52) U.S. Cl. 370/328

(57) ABSTRACT

When there are different power classes of base stations (BSs), there may be a need to coordinate transmission from the different BSs to reduce interference to a user equipment (UE) on both control channels and data channels. There are different ways of coordination. For some embodiments, time division multiplex (TDM) resource partitioning may be performed across BSs on a subframe level. TDM resource partitioning may avoid control channel interference since resource mapping on time and frequency for control channels may span the whole frequency domain. However, the data rate for the UE may be limited due to the TDM partitioning of subframes. In other words, a limitation may derive from control channel interference coordination. For some embodiments, a UE may transmit and/or receive in subframes other than the ones partitioned for the UE.

### CROSS-REFERENCE TO RELATED APPLICATION

This application claims priority to U.S. Provisional Application Ser. No. 61/357,878, filed on Jun. 23, 2010, which is expressly incorporated by reference herein in its entirety.

### BACKGROUND

I. Field

The present disclosure relates generally to communication and, more specifically, to techniques for supporting communication in a wireless communication network.

II. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may observe interference due to transmissions from neighbor base stations. On the uplink, a transmission from the UE may cause interference to transmissions from other UEs communicating with the neighbor base stations. The interference may degrade performance on both the downlink and uplink.

### SUMMARY

In an aspect of the disclosure, a method for wireless communication is provided. The method generally includes identifying subframes that are protected due to cooperative partitioning of resources between a serving Node B and one or more non-serving Node Bs, transmitting, on a subframe allocated to the serving Node B, a grant message for a downlink transmission in a subset of the subframes allocated to the one or more non-serving Node Bs, and identifying one or more reference signals, to be transmitted in the subset of the subframes, that are usable by a user equipment (UE).

In an aspect of the disclosure, an apparatus for wireless communication is provided. The apparatus generally includes means for identifying subframes that are protected due to cooperative partitioning of resources between a serving Node B and one or more non-serving Node Bs, means for transmitting, on a subframe allocated to the serving Node B, a grant message for a downlink transmission in a subset of the subframes allocated to the one or more non-serving Node Bs, and means for identifying one or more reference signals, to be transmitted in the subset of the subframes, which are usable by a user equipment (UE).

In an aspect of the disclosure, an apparatus for wireless communication is provided. The apparatus generally includes at least one processor and a memory coupled to the at least one processor. The at least one processor is generally configured to identify subframes that are protected due to cooperative partitioning of resources between a serving Node B and one or more non-serving Node Bs, transmit, on a subframe allocated to the serving Node B, a grant message for a downlink transmission in a subset of the subframes allocated to the one or more non-serving Node Bs, and identify one or more reference signals, to be transmitted in the subset of the subframes, which are usable by a user equipment (UE).

In an aspect of the disclosure, a computer-program product for wireless communication is provided. The computer-program product generally includes a computer-readable medium having code for identifying subframes that are protected due to cooperative partitioning of resources between a serving Node B and one or more non-serving Node Bs, transmitting, on a subframe allocated to the serving Node B, a grant message for a downlink transmission in a subset of the subframes allocated to the one or more non-serving Node Bs, and identifying one or more reference signals, to be transmitted in the subset of the subframes, which are usable by a user equipment (UE).

In an aspect of the disclosure, a method for wireless communication is provided. The method generally includes receiving, on a subframe allocated to a serving Node B, a grant message for a downlink transmission in a subset of subframes allocated to one or more non-serving Node Bs, and receiving a signal indicating one or more reference signals, to be received in the subset of the subframes, that are usable by a user equipment (UE).

In an aspect of the disclosure, an apparatus for wireless communication is provided. The apparatus generally includes means for receiving, on a subframe allocated to a serving Node B, a grant message for a downlink transmission in a subset of subframes allocated to one or more non-serving Node Bs, and means for receiving a signal indicating one or more reference signals, to be received in the subset of the subframes, which are usable by a user equipment (UE).

In an aspect of the disclosure, an apparatus for wireless communication is provided. The apparatus generally includes at least one processor and a memory coupled to the at least one processor. The at least one processor is generally configured to receive, on a subframe allocated to a serving Node B, a grant message for a downlink transmission in a subset of subframes allocated to one or more non-serving Node Bs, and receive a signal indicating one or more reference signals, to be received in the subset of the subframes, which are usable by a user equipment (UE).

In an aspect of the disclosure, a computer-program product for wireless communication is provided. The computer-program product generally includes a computer-readable medium having code for receiving, on a subframe allocated to a serving Node B, a grant message for a downlink transmission in a subset of subframes allocated to one or more non-serving Node Bs, and receiving a signal indicating one or more reference signals, to be received in the subset of the subframes, which are usable by a user equipment (UE).

### BRIEF DESCRIPTION OF THE DRAWINGS

FIG. 1 is a block diagram conceptually illustrating an example of a wireless communications network in accordance with certain aspects of the present disclosure.

FIG. 2 shows a block diagram conceptually illustrating an example of a Node B in communication with a user equipment device (UE) in a wireless communications network in accordance with certain aspects of the present disclosure.

FIG. 3 is a block diagram conceptually illustrating an example of a frame structure in a wireless communications network in accordance with certain aspects of the present disclosure.

FIG. 4 illustrates two exemplary subframe formats for the downlink with the normal cyclic prefix in accordance with certain aspects of the present disclosure.

FIG. 5 illustrates an exemplary dominant interference scenario in accordance with certain aspects of the present disclosure.

FIG. 6 illustrates example cooperative partitioning of sub-frames in a heterogeneous network in accordance with certain aspects of the present disclosure.

FIG. 7 illustrates an example of resource collision between two base stations (BSs), in accordance with certain aspects of the present disclosure.

FIG. 8 illustrates an example system with a serving BS and a UE, capable of identifying a subset of reference signals (RSs) from a non-serving BS that are usable by the UE, in accordance with certain aspects of the present disclosure.

FIG. 9 illustrates example operations for identifying RSs that are usable by a UE, which may avoid collision with data transmitted from a BS, in accordance with certain aspects of the present disclosure.

FIG. 10 illustrates example operations for using RSs indicated as usable from a BS, in accordance with certain aspects of the present disclosure.

### DETAILED DESCRIPTION

When there are different power classes of base stations (BSs), there may be a need to coordinate transmission from the different BSs to reduce interference to a user equipment (UE) on both control channels and data channels. There are different ways of coordination. For some embodiments, time division multiplex (TDM) resource partitioning may be performed across BSs on a subframe level. TDM resource partitioning may avoid control channel interference since resource mapping on time and frequency for control channels may span the whole frequency domain. However, the data rate for the UE may be limited due to the TDM partitioning of subframes. In other words, a limitation may derive from control channel interference coordination. For some embodiments, a UE may transmit and/or receive in subframes other than the ones partitioned for the UE, as will be described further.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA), Time Division Synchronous CDMA (TD-SCDMA), and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A), in both frequency division duplexing (FDD) and time division duplexing (TDD), are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

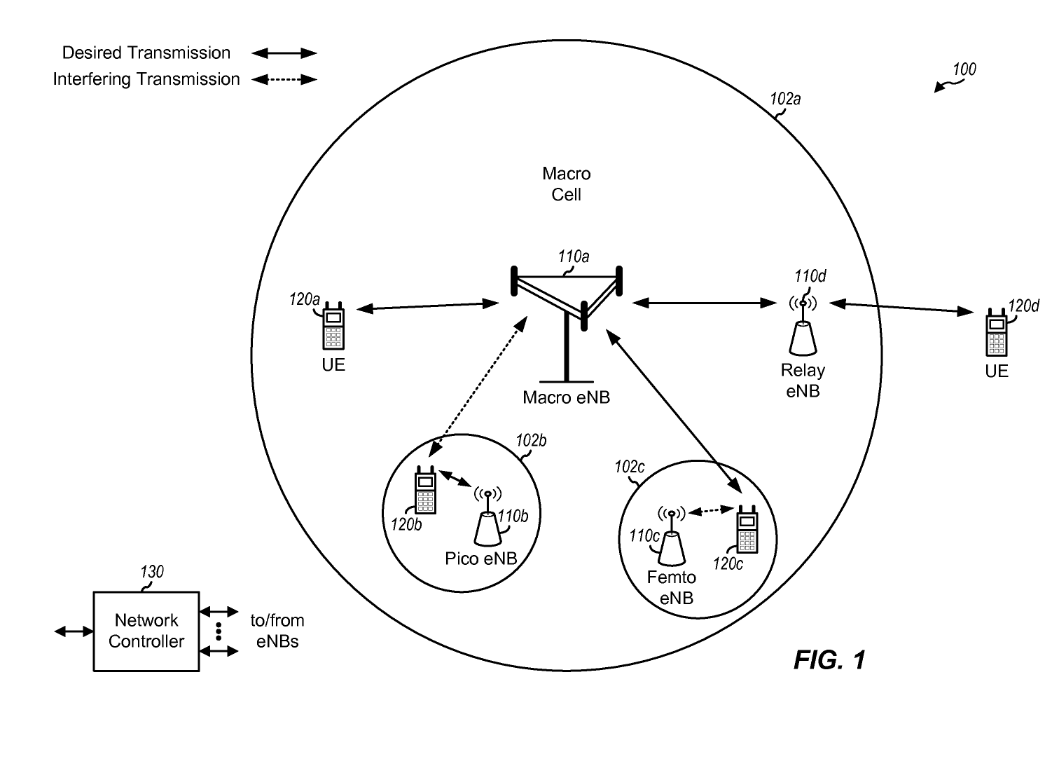

FIG. 1 shows a wireless communication network 100 in which procedures described for identifying usable reference signals from a non-serving eNB may be performed. The network 100 may be an LTE network or some other wireless network. Wireless network 100 may include a number of evolved Node Bs (eNBs) 110 and other network entities. An eNB is an entity that communicates with UEs and may also be referred to as a base station, a Node B, an access point, etc. Each eNB may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG)). An eNB for a macro cell may be referred to as a macro eNB. An eNB for a pico cell may be referred to as a pico eNB. An eNB for a femto cell may be referred to as a femto eNB or a home eNB (HeNB). In the example shown in FIG. 1, an eNB 110a may be a macro eNB for a macro cell 102a, an eNB 110b may be a pico eNB for a pico cell 102b, and an eNB 110c may be a femto eNB for a femto cell 102c. An eNB may support one or multiple (e.g., three) cells. The terms “eNB”, “base station” and “cell” may be used interchangeably herein.

Wireless network 100 may also include relay stations. A relay station is an entity that can receive a transmission of data from an upstream station (e.g., an eNB or a UE) and send a transmission of the data to a downstream station (e.g., a UE or an eNB). A relay station may also be a UE that can relay transmissions for other UEs. In the example shown in FIG. 1, a relay station 110d may communicate with macro eNB 110a and a UE 120d in order to facilitate communication between eNB 110a and UE 120d. A relay station may also be referred to as a relay eNB, a relay base station, a relay, etc.

Wireless network 100 may be a heterogeneous network that includes eNBs of different types, e.g., macro eNBs, pico eNBs, femto eNBs, relay eNBs, etc. These different types of eNBs may have different transmit power levels, different coverage areas, and different impact on interference in wireless network 100. For example, macro eNBs may have a high transmit power level (e.g., 5 to 40 Watts) whereas pico eNBs, femto eNBs, and relay eNBs may have lower transmit power levels (e.g., 0.1 to 2 Watts).

A network controller 130 may couple to a set of eNBs and may provide coordination and control for these eNBs. Network controller 130 may communicate with the eNBs via a backhaul. The eNBs may also communicate with one another, e.g., directly or indirectly via a wireless or wireline backhaul.

As will be described in greater detail below, according to certain aspects, eNBs may perform inter-cell interference coordination (ICIC). ICIC may involve negotiation between eNBs to achieve resource coordination/partitioning to allocate resources to an eNB located near the vicinity of a strong interfering eNB. The interfering eNB may avoid transmitting on the allocated/protected resources, possibly except for a CRS. A UE can then communicate with the eNB on the protected resources in the presence of the interfering eNB and may observe no interference (possibly except for the CRS) from the interfering eNB

UEs 120 may be dispersed throughout wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a netbook, a smartbook, etc.

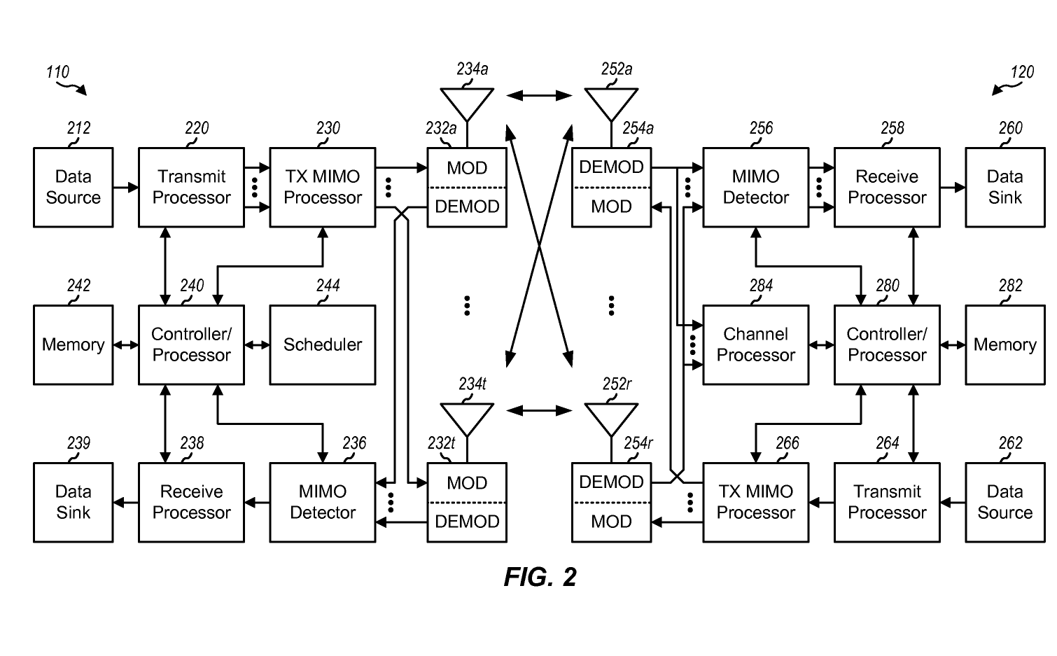

FIG. 2 shows a block diagram of a design of base station/eNB 110 and UE 120, which may be one of the base stations/eNBs and one of the UEs in FIG. 1. Base station 110 may be equipped with T antennas 234a through 234t, and UE 120 may be equipped with R antennas 252a through 252r, where in general T≧1 and R≧1.

At base station 110, a transmit processor 220 may receive data from a data source 212 for one or more UEs, select one or more modulation and coding schemes (MCS) for each UE based on CQIs received from the UE, process (e.g., encode and modulate) the data for each UE based on the MCS(s) selected for the UE, and provide data symbols for all UEs. Transmit processor 220 may also process system information (e.g., for SRPI, etc.) and control information (e.g., CQI requests, grants, upper layer signaling, etc.) and provide overhead symbols and control symbols. Processor 220 may also generate reference symbols for reference signals (e.g., the CRS) and synchronization signals (e.g., the PSS and SSS). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) its received signal to obtain input samples. Each demodulator 254 may further process the input samples (e.g., for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor 284 may determine RSRP, RSSI, RSRQ, CQI, etc., as described below.

On the uplink, at UE 120, a transmit processor 264 may receive and process data from a data source 262 and control information (e.g., for reports comprising RSRP, RSSI, RSRQ, CQI, etc.) from controller/processor 280. Processor 264 may also generate reference symbols for one or more reference signals. The symbols from transmit processor 264 may be precoded by a TX MIMO processor 266 if applicable, further processed by modulators 254a through 254r (e.g., for SC-FDM, OFDM, etc.), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Processor 238 may provide the decoded data to a data sink 239 and the decoded control information to controller/processor 240.

Controllers/processors 240 and 280 may direct the operation at base station 110 and UE 120, respectively. Processor 240 and/or other processors and modules at base station 110 may perform or direct operations for configuring a UE for various random access procedures and identify one or more attributes during such procedures, as described herein. For example, processor 280 and/or other processors and modules at UE 120 may perform or direct operations for various random access procedures described herein. Memories 242 and 282 may store data and program codes for base station 110 and UE 120, respectively. A scheduler 244 may schedule UEs for data transmission on the downlink and/or uplink.

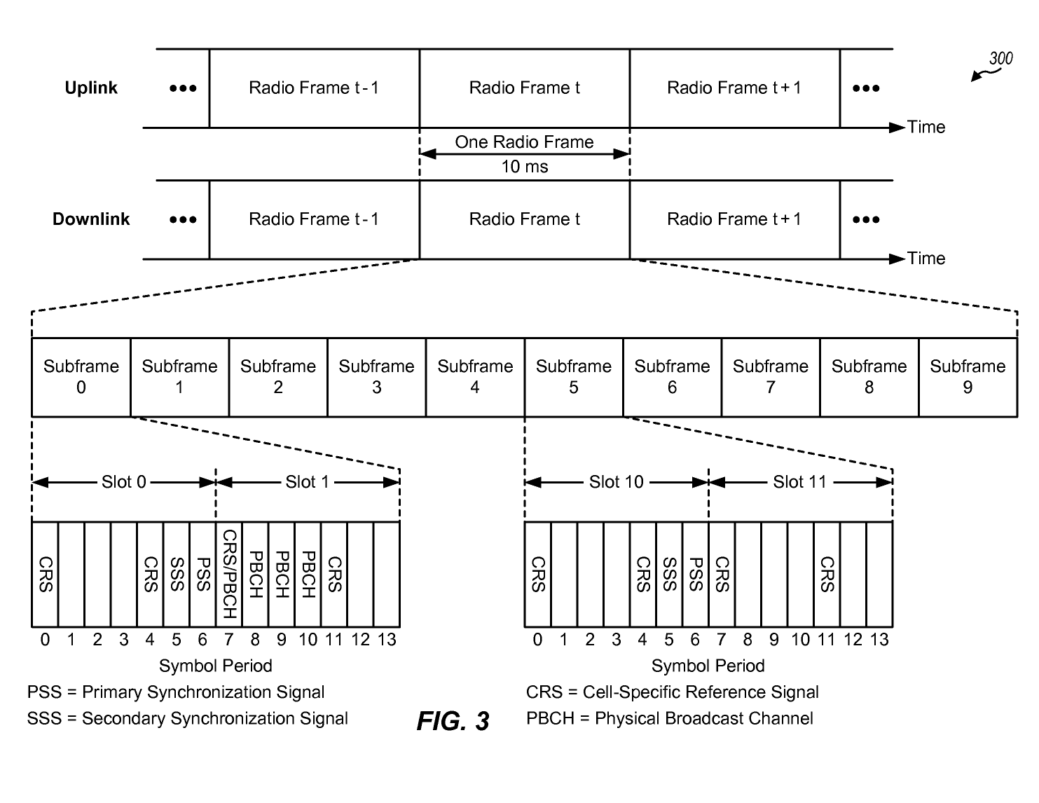

FIG. 3 shows an exemplary frame structure 300 for FDD in LTE. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., seven symbol periods for a normal cyclic prefix or six symbol periods for an extended cyclic prefix. The 2L symbol periods in each subframe may be assigned indices of 0 through 2L−1.

In LTE, an eNB may transmit a primary synchronization signal (PSS) and a secondary synchronization signal (SSS) on the downlink in the center 1.08 MHz of the system bandwidth for each cell supported by the eNB. The PSS and SSS may be transmitted in symbol periods 6 and 5, respectively, in subframes 0 and 5 of each radio frame with the normal cyclic prefix, as shown in FIG. 3. The PSS and SSS may be used by UEs for cell search and acquisition. The eNB may transmit a cell-specific reference signal (CRS) across the system bandwidth for each cell supported by the eNB. The CRS may be transmitted in certain symbol periods of each subframe and may be used by the UEs to perform channel estimation, channel quality measurement, and/or other functions. The eNB may also transmit a Physical Broadcast Channel (PBCH) in symbol periods 0 to 3 in slot 1 of certain radio frames. The PBCH may carry some system information. The eNB may transmit other system information such as System Information Blocks (SIBs) on a Physical Downlink Shared Channel (PDSCH) in certain subframes. The eNB may transmit control information/data on a Physical Downlink Control Channel (PDCCH) in the first B symbol periods of a subframe, where B may be configurable for each subframe. The eNB may transmit traffic data and/or other data on the PDSCH in the remaining symbol periods of each subframe.

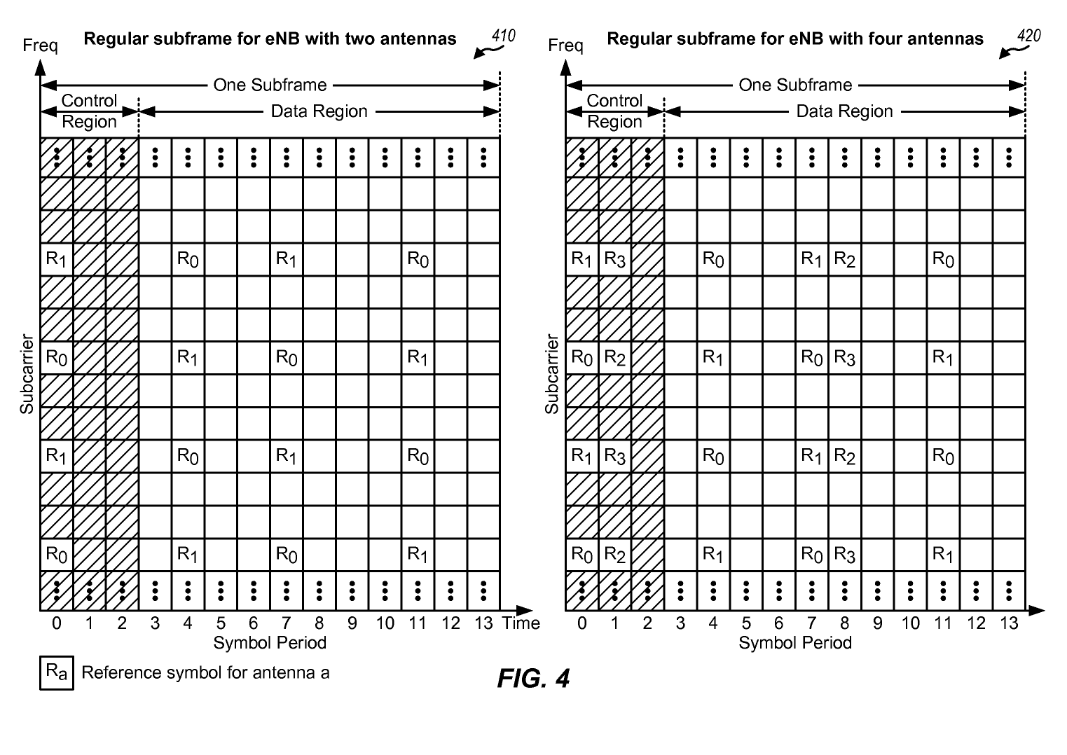

FIG. 4 shows two exemplary subframe formats 410 and 420 for the downlink with the normal cyclic prefix. The available time frequency resources for the downlink may be partitioned into resource blocks. Each resource block may cover 12 subcarriers in one slot and may include a number of resource elements. Each resource element may cover one subcarrier in one symbol period and may be used to send one modulation symbol, which may be a real or complex value.

Subframe format 410 may be used for an eNB equipped with two antennas. A CRS may be transmitted from antennas 0 and 1 in symbol periods 0, 4, 7 and 11. A reference signal is a signal that is known a priori by a transmitter and a receiver and may also be referred to as pilot. A CRS is a reference signal that is specific for a cell, e.g., generated based on a cell identity (ID). In FIG. 4, for a given resource element with label Rₐ, a modulation symbol may be transmitted on that resource element from antenna a, and no modulation symbols may be transmitted on that resource element from other antennas. Subframe format 420 may be used for an eNB equipped with four antennas. A CRS may be transmitted from antennas 0 and 1 in symbol periods 0, 4, 7 and 11 and from antennas 2 and 3 in symbol periods 1 and 8. For both subframe formats 410 and 420, a CRS may be transmitted on evenly spaced subcarriers, which may be determined based on cell ID. Different eNBs may transmit their CRSs on the same or different subcarriers, depending on their cell IDs. For both subframe formats 410 and 420, resource elements not used for the CRS may be used to transmit data (e.g., traffic data, control data, and/or other data).

The PSS, SSS, CRS and PBCH in LTE are described in 3GPP TS 36.211, entitled “Evolved Universal Terrestrial Radio Access (E-UTRA); Physical Channels and Modulation,” which is publicly available.

An interlace structure may be used for each of the downlink and uplink for FDD in LTE. For example, Q interlaces with indices of 0 through Q−1 may be defined, where Q may be equal to 4, 6, 8, 10, or some other value. Each interlace may include subframes that are spaced apart by Q frames. In particular, interlace q may include subframes q, q+Q, q+2Q, etc., where q ε{0, . . . , Q−1}.

The wireless network may support hybrid automatic retransmission (HARQ) for data transmission on the downlink and uplink. For HARQ, a transmitter (e.g., an eNB) may send one or more transmissions of a packet until the packet is decoded correctly by a receiver (e.g., a UE) or some other termination condition is encountered. For synchronous HARQ, all transmissions of the packet may be sent in subframes of a single interlace. For asynchronous HARQ, each transmission of the packet may be sent in any subframe.

A UE may be located within the coverage of multiple eNBs. One of these eNBs may be selected to serve the UE. The serving eNB may be selected based on various criteria such as received signal strength, received signal quality, pathloss, etc. Received signal quality may be quantified by a signal-to-noise-and-interference ratio (SINR), or a reference signal received quality (RSRQ), or some other metric. The UE may operate in a dominant interference scenario in which the UE may observe high interference from one or more interfering eNBs.

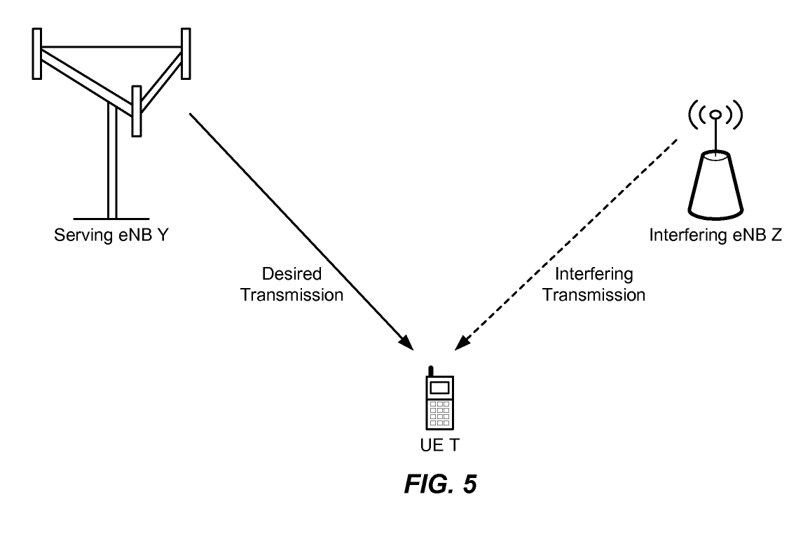

FIG. 5 shows an exemplary dominant interference scenario. In the example shown in FIG. 5, a UE T may communicate with a serving eNB Y and may observe high interference from a strong/dominant interfering eNB Z.

A dominant interference scenario may occur due to restricted association. For example, in FIG. 5, eNB Y may be a macro eNB, and eNB Z may be a femto eNB. UE T may be located close to femto eNB Z and may have high received power for eNB Z. However, UE T may not be able to access femto eNB Z due to restricted association and may then connect to macro eNB Y with lower received power. UE T may then observe high interference from femto eNB Z on the downlink and may also cause high interference to femto eNB Z on the uplink.

A dominant interference scenario may also occur due to range extension, which is a scenario in which a UE connects to an eNB with lower pathloss and possibly lower SINR among all eNBs detected by the UE. For example, in FIG. 5, eNB Y may be a pico eNB, and interfering eNB Z may be a macro eNB. UE T may be located closer to pico eNB Y than macro eNB Z and may have lower pathloss for pico eNB Y. However, UE T may have lower received power for pico eNB Y than macro eNB Z due to a lower transmit power level of pico eNB Y as compared to macro eNB Z. Nevertheless, it may be desirable for UE T to connect to pico eNB Y due to the lower pathloss. This may result in less interference to the wireless network for a given data rate for UE T.

In general, a UE may be located within the coverage of any number of eNBs. One eNB may be selected to serve the UE, and the remaining eNBs may be interfering eNBs. The UE may thus have any number of interfering eNBs. For clarity, much of the description assumes the scenario shown in FIG. 5 with one serving eNB Y and one interfering eNB Z.

Communication in a dominant interference scenario may be supported by performing inter-cell interference coordination (ICIC). According to certain aspects of ICIC, resource coordination/partitioning may be performed to allocate resources to an eNB located near the vicinity of a strong interfering eNB. The interfering eNB may avoid transmitting on the allocated/protected resources, possibly except for a CRS. A UE can then communicate with the eNB on the protected resources in the presence of the interfering eNB and may observe no interference (possibly except for the CRS) from the interfering eNB.

In general, time and/or frequency resources may be allocated to eNBs via resource partitioning. According to certain aspects, the system bandwidth may be partitioned into a number of subbands, and one or more subbands may be allocated to an eNB. In another design, a set of subframes may be allocated to an eNB. In yet another design, a set of resource blocks may be allocated to an eNB. For clarity, much of the description below assumes a time division multiplex (TDM) resource partitioning design in which one or more interlaces may be allocated to an eNB. The subframes of the allocated interlace(s) may observe reduced or no interference from strong interfering eNBs.

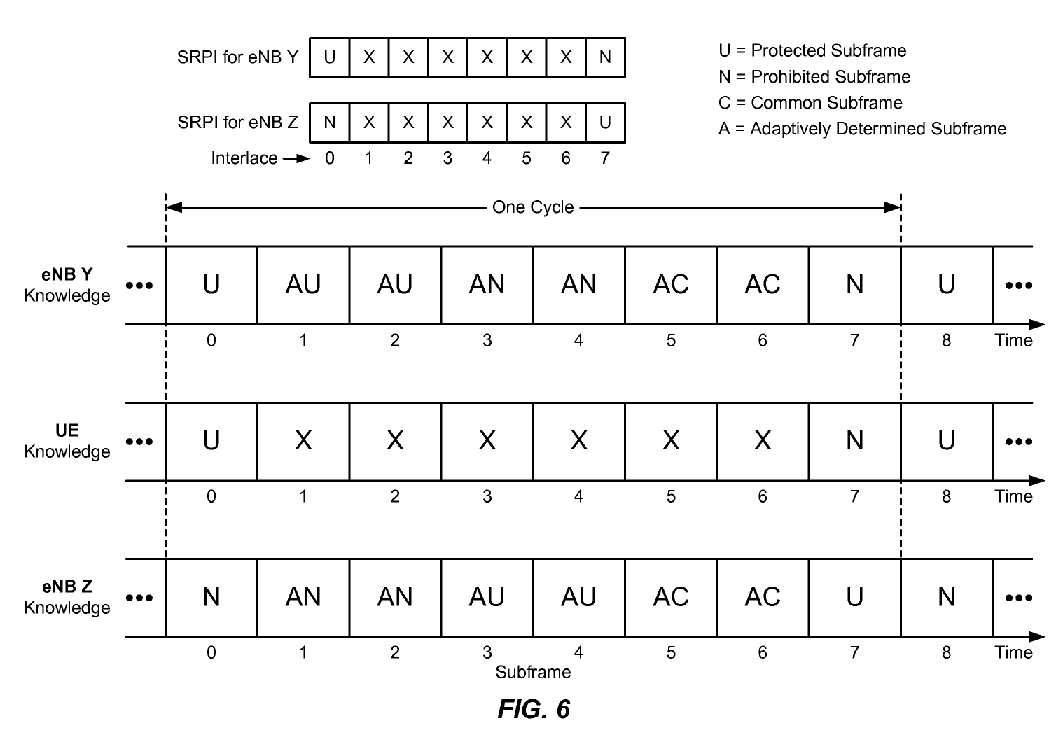

FIG. 6 shows an example of TDM resource partitioning to support communication in the dominant interference scenario in FIG. 5. In the example shown in FIG. 6, eNB Y may be allocated interlace 0, and eNB Z may be allocated interlace 7 in a semi-static or static manner, e.g., via negotiation between the eNBs through the backhaul. eNB Y can transmit data in subframes of interlace 0 and may avoid transmitting data in subframes of interlace 7. Conversely, eNB Z can transmit data in subframes of interlace 7 and may avoid transmitting data in subframes of interlace 0. The subframes of the remaining interlaces 1 through 6 may be adaptively/dynamically allocated to eNB Y and/or eNB Z.

Table 1 lists different types of subframes in accordance with one design. From the perspective of eNB Y, an interlace allocated to eNB Y may include “protected” subframes (U subframes) that can be used by eNB Y and having little or no interference from interfering eNBs. An interlace allocated to another eNB Z may include “prohibited” subframes (N subframes) that cannot be used by eNB Y for data transmission. An interlace not allocated to any eNB may include “common” subframes (C subframes) that can be used by different eNBs. A subframe that is adaptively allocated is denoted with an “A” prefix and may be a protected subframe (AU subframe), or a prohibited subframe (AN subframe), or a common subframe (AC subframe). The different types of subframes may also be referred to by other names. For example, a protected subframe may be referred to as a reserved subframe, an allocated subframe, etc.

TABLE 1
Subframe Types

| Subframe | | Expected |
|---|---|---|
| Type | Description | CQI |
| U | Protected subframe that can be used for data | High |
| | transmission and having reduced or no | CQI |
| | interference from interfering eNBs. | |
| N | Prohibited subframe that cannot be used for data | Low CQI |
| | transmission. | |
| C | Common subframe that can be used for data | High or |
| | transmission by different eNBs. | Low CQI |

According to certain aspects, an eNB may transmit static resource partitioning information (SRPI) to its UEs. According to certain aspects, the SRPI may comprise Q fields for the Q interlaces. The field for each interlace may be set to “U” to indicate the interlace being allocated to the eNB and including U subframes, or to “N” to indicate the interlace being allocated to another eNB and including N subframes, or to “X” to indicate the interlace being adaptively allocated to any eNB and including X subframes. A UE may receive the SRPI from the eNB and can identify U subframes and N subframes for the eNB based on the SRPI. For each interlace marked as “X” in the SRPI, the UE may not know whether the X subframes in that interlace will be AU subframes, or AN subframes, or AC subframes. The UE may know only the semi-static part of the resource partitioning via the SRPI whereas the eNB may know both the semi-static part and adaptive part of the resource partitioning. In the example shown in FIG. 6, the SRPI for eNB Y may include “U” for interlace 0, “N” for interlace 7, and “X” for each remaining interlace. The SRPI for eNB Z may include “U” for interlace 7, “N” for interlace 0, and “X” for each remaining interlace.

A UE may estimate received signal quality of a serving eNB based on a CRS from the serving eNB. The UE may determine CQI based on the received signal quality and may report the CQI to the serving eNB. The serving eNB may use the CQI for link adaptation to select a modulation and coding scheme (MCS) for data transmission to the UE. Different types of subframes may have different amounts of interference and hence may have very different CQIs. In particular, protected subframes (e.g., U and AU subframes) may be characterized by better CQI since dominant interfering eNBs do not transmit in these subframes. In contrast, CQI may be much worse for other subframes (e.g., N, AN and AC subframes) in which one or more dominant interfering eNBs can transmit. From the point of view of CQI, AU subframes may be equivalent to U subframes (both are protected), and AN subframes may be equivalent to N subframes (both are prohibited). AC subframes may be characterized by a completely different CQI. To achieve good link adaptation performance, the serving eNB should have relatively accurate CQI for each subframe in which the eNB transmits traffic data to the UE.

### Methods of Control/Data Partition Scheme in Heterogeneous Networks for LTE-A

When there are different power classes of eNBs, there may be a need to coordinate transmission from the different eNBs to reduce interference to a UE on both control channels and data channels. There are different ways of coordination. For some embodiments, time division multiplex (TDM) resource partitioning may be performed across eNBs on a subframe level. TDM resource partitioning may avoid control channel interference since resource mapping on time and frequency for control channels may span the whole frequency domain. However, the data rate for the UE may be limited due to the TDM partitioning of subframes. In other words, a limitation may derive from control channel interference coordination. For some embodiments, a UE may transmit and/or receive in subframes other than the ones partitioned for the UE, as will be described further.

For some embodiments, TDM resource partitioning may be performed across eNBs on a subframe level. For example, there may be a TDM partitioning of subframes between two eNBs that may have two different power classes, wherein the partition may be in a periodicity of eight. For example, referring back to FIG. 5, a UE T may communicate with a serving eNB Y and may observe high interference from a strong/dominant interfering eNB Z.

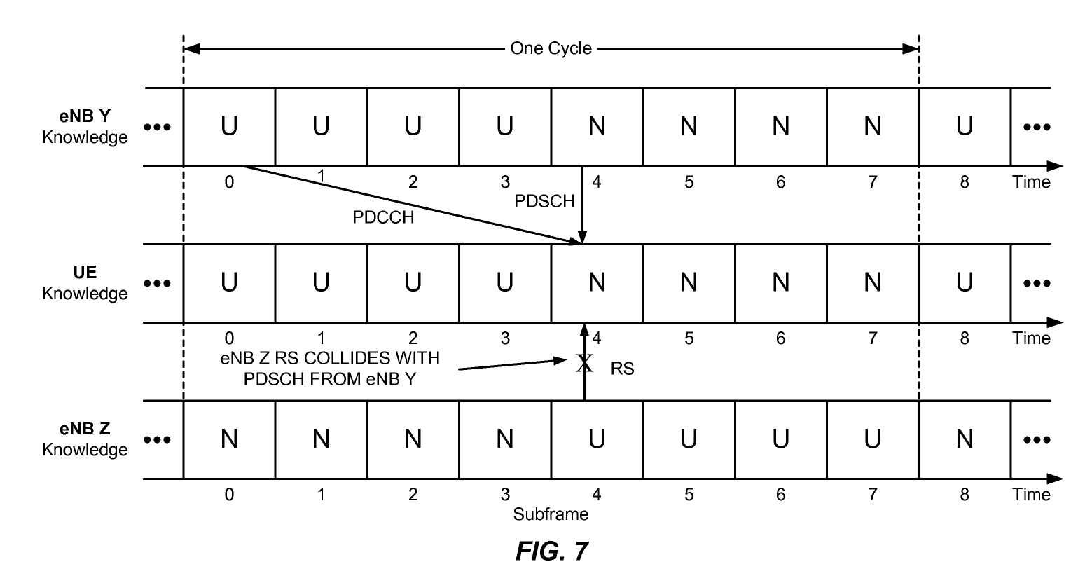

FIG. 7 illustrates an example of TDM resource partitioning to support communication in the dominant interference scenario in FIG. 5. In the example shown in FIG. 7, eNB Y may be allocated subframes 0-3, and eNB Z may be allocated subframes 4-7 in a semi-static or static manner, e.g., via negotiation between the eNBs through the backhaul. eNB Y can transmit data in subframes 0-3 and may avoid transmitting data in subframes 4-7. Conversely, eNB Z can transmit data in subframes 4-7 and may avoid transmitting data in subframes 0-3.

UE T may only receive a DL/UL grant from subframe {0, 1, 2, and 3} with the TDM partition scheme. For some embodiments, UE T may receive a DL/UL grant (e.g., PDCCH) in subframe {0, 1, 2, and 3} but those grants may be used in subframes allocated to eNB Z {4, 5, 6, and 7} (i.e., cross-subframe assignment). Referring to FIG. 7, UE T may receive a PDCCH in subframe 0 for a PDSCH in subframe 4. However, the PDSCH received in subframe 4 may impact reference signals (e.g., common reference signal (CRS)) for eNB Z on subframe 4 (i.e., if the CRS frequency shift for eNBs Y and Z are different, wherein the frequency shift may be a function of the cell ID). In other words, reference signals (RSs) that UE T receives from eNB Z may be too noisy to be inadequate for performing radio resource management (RRM) measurements of eNB Z (e.g., RSs from eNB Z may collide with PDSCH from eNB Y, as illustrated in FIG. 7).

As another example, the CRSs from eNB Y in subframes {4, 5, 6, and 7} may be impacted by the PDSCH from eNB Z if UE T needs to use the CRSs for demodulation or decoding of PDSCH from eNB Y. In other words, RSs that UE T receives from eNB Y may be too noisy to do serving cell channel estimation to demodulate/decode the cross-subframe PDSCH transmitted from eNB Y.

For some embodiments, an eNB may coordinate on subframes on control channels through TDM partitioning, as described above. In addition, the eNB may apply a cross-subframe assignment such that the UE may transmit or decode data on the subframes not assigned to the eNB that the UE is associated with (i.e., serving cell). Further, the eNB may specify (e.g., by layer 3 signaling or layer 1 signaling) to the UE to use a subset of CRSs or a Channel State Information Reference Signals (CSI-RSs) (contiguous or non-contiguous) for measurements (e.g., reference signal received power (RSRP)/RLM/CQI) and/or demodulation/decoding on those subframes where PDCCH grants may be from cross-subframe assignments.

From the UE receiver perspective, the UE may use a subset of CRSs for channel estimation on those subframes where PDCCH grants may be from cross-subframe assignments. The UE may use the subset of CRSs if the CRS frequency shifts may be different from the serving and non-serving eNBs. When the CRS frequency shifts are the same from the serving and non-serving eNBs, the UE may use the entire set of CRSs for channel estimation. Referring back to FIG. 7, UE T may receive a subset of RSs from eNB Z without colliding with the PDSCH received from eNB Y, allowing UE T to perform RRM measurements of eNB Z. As another example, referring back to FIG. 7, UE T may receive a subset of RSs from eNB Y without colliding with the PDSCH transmitted from eNB Z (not shown), allowing UE T to perform serving cell channel estimation to demodulate/decode the cross-subframe PDSCH transmitted from eNB Y.

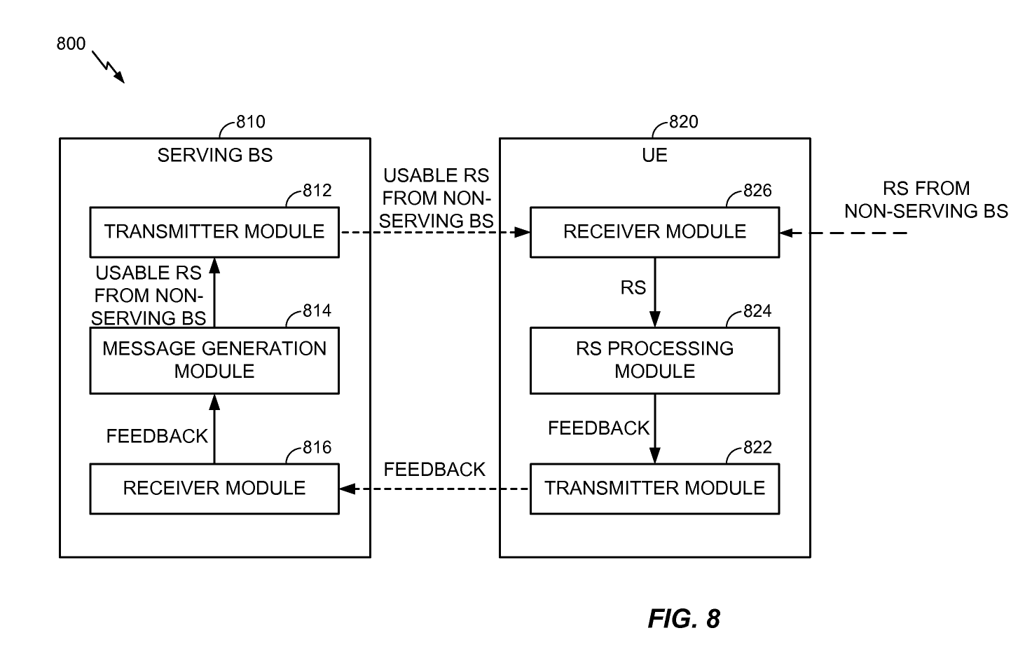

FIG. 8 illustrates an example system 800 with a serving base station (BS) 810 and a user equipment (UE) 820, capable of identifying a subset of reference signals (RSs) from a non-serving BS that are usable by the UE 820, as will be discussed further herein. As described earlier, UE 820 may receive a DL/UL grant in a subframe allocated to the serving BS 810, but the grant may be used in a subframe allocated to the non-serving BS (i.e., cross-subframe assignment). Therefore, RSs from the non-serving BS may collide with the data transmitted from the serving BS 810 (e.g., PDSCH). For some embodiments, the serving BS 810 may identify usable RSs from the non-serving BS that may avoid collision with the data transmitted from the serving BS 810. As illustrated, the serving BS 810 may include a message generation module 814 for generating a signal identifying the usable RSs, wherein the signal may be transmitted, via a transmitter module 812, to the UE 820 (e.g., by layer 3 signaling or layer 1 signaling).

The UE 820 may receive the signal and receive RSs from the non-serving BS via a receiver module 826. The UE 820 may process the usable RSs from the non-serving BS (i.e., a subset of the RSs from the non-serving BS) via a RS processing module 824 and perform RRM measurements using the usable RSs from the non-serving BS. After performing RRM measurements, the UE 820 may transmit feedback via a transmitter module 822, and the serving BS 810 may receive the feedback via a receiver module 816.

For some embodiments, the serving BS 810 may generate a signal identifying usable RSs from the serving BS 810 that may avoid collision with data transmitted from the non-serving BS (e.g., PDSCH) (not shown). The UE 820 may receive the signal and receive RSs from the serving BS 810. Using the usable RSs, the UE 820 may perform serving cell channel estimation to demodulate/decode the cross-subframe PDSCH transmitted from the serving BS 810.

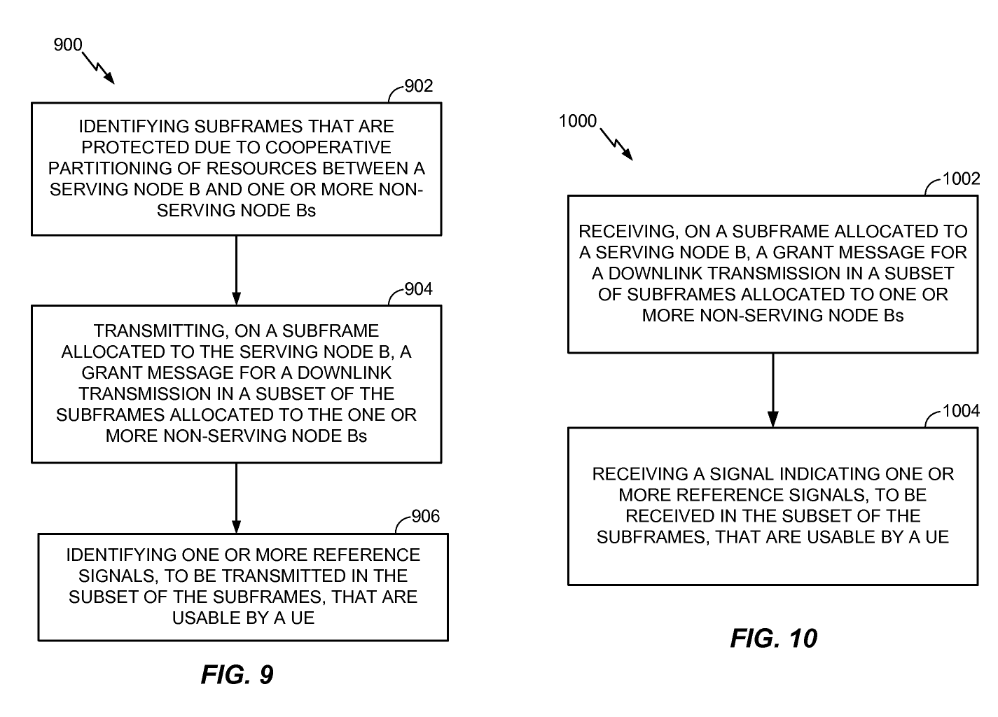

FIG. 9 illustrates example operations 900 for identifying RSs that are usable by a UE, which may avoid collision with data transmitted from a Node B, in accordance with certain aspects of the present disclosure. The operations 900 may be performed, for example, by a serving Node B. At 902, the serving Node B may identify subframes that are protected due to cooperative partitioning of resources between the serving Node B and one or more non-serving Node Bs. At 904, the serving Node B may transmit, on a subframe allocated to the serving Node B, a grant message for a downlink transmission in a subset of the subframes allocated to the one or more non-serving Node Bs (i.e., cross-subframe assignment). At 906, the serving Node B may identify one or more RSs, to be transmitted in the subset of the subframes, that are usable by a UE. The serving Node B may signal to the UE to use the one or more RSs through at least one of layer 3 signaling or layer 1 signaling. For some embodiments, the UE may use one or more RSs transmitted from a non-serving Node B to perform RRM measurements of the non-serving Node B. For some embodiments, the UE may use one or more RSs transmitted from the serving Node B to perform serving cell channel estimation to demodulate/decode the cross-subframe downlink transmission (e.g., PDSCH) transmitted from the serving Node B. The one or more RSs may be contiguous or non-contiguous.

FIG. 10 illustrates example operations 1000 for using RSs indicated as usable from a Node B, in accordance with certain aspects of the present disclosure. The operations 1000 may be performed, for example, by a UE. At 1002, the UE may receive, on a subframe allocated to a serving Node B, a grant message for a downlink transmission in a subset of subframes allocated to one or more non-serving Node Bs. At 1004, the UE may receive a signal indicating one or more RSs, to be received in the subset of the subframes, which are usable by a user equipment (UE). For some embodiments, the UE may perform RRM measurements on the subset of the subframes using one or more RSs transmitted from a non-serving Node B. For some embodiments, the UE may use one or more RSs transmitted from the serving Node B to perform channel estimation for demodulating and decoding downlink transmissions from the serving Node B on the subset of the subframes.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
identifying subframes that are protected due to cooperative partitioning of resources between a serving Node B and one or more non-serving Node Bs;
transmitting, on a subframe allocated to the serving Node B, a grant message for a downlink transmission in a subset of the subframes allocated to the one or more non-serving Node Bs; and
identifying one or more reference signals, to be transmitted in the subset of the subframes, which are usable by a user equipment (UE).

2. The method of claim 1, further comprising signaling to the UE, through at least one of layer 3 signaling or layer 1 signaling, to use the one or more reference signals for performing at least one of measurements, demodulation, and decoding.

3. The method of claim 1, wherein the one or more reference signals are contiguous.

4. An apparatus for wireless communication, comprising:
means for identifying subframes that are protected due to cooperative partitioning of resources between a serving Node B and one or more non-serving Node Bs;
means for transmitting, on a subframe allocated to the serving Node B, a grant message for a downlink transmission in a subset of the subframes allocated to the one or more non-serving Node Bs; and
means for identifying one or more reference signals, to be transmitted in the subset of the subframes, which are usable by a user equipment (UE).

5. The apparatus of claim 4, further comprising means for signaling to the UE, through at least one of layer 3 signaling or layer 1 signaling, to use the one or more reference signals for performing at least one of measurements, demodulation, and decoding.

6. The apparatus of claim 4, wherein the one or more reference signals are contiguous.

7. An apparatus for wireless communication, comprising:
at least one processor configured to:
identify subframes that are protected due to cooperative partitioning of resources between a serving Node B and one or more non-serving Node Bs;
transmit, on a subframe allocated to the serving Node B, a grant message for a downlink transmission in a subset of the subframes allocated to the one or more non-serving Node Bs; and
identify one or more reference signals, to be transmitted in the subset of the subframes, which are usable by a user equipment (UE); and
a memory coupled to the at least one processor.

8. The apparatus of claim 7, wherein the at least one processor is configured to signal to the UE, through at least one of layer 3 signaling or layer 1 signaling, to use the one or more reference signals for performing at least one of measurements, demodulation, and decoding.

9. The apparatus of claim 7, wherein the one or more reference signals are contiguous.

10. A computer-program product for wireless communication, the computer-program product comprising:
a computer-readable medium having code for:
identifying subframes that are protected due to cooperative partitioning of resources between a serving Node B and one or more non-serving Node Bs;
transmitting, on a subframe allocated to the serving Node B, a grant message for a downlink transmission in a subset of the subframes allocated to the one or more non-serving Node Bs; and
identifying one or more reference signals, to be transmitted in the subset of the subframes, which are usable by a user equipment (UE).

11. The computer-program product of claim 10, further comprising code for signaling to the UE, through at least one of layer 3 signaling or layer 1 signaling, to use the one or more reference signals for performing at least one of measurements, demodulation, and decoding.

12. The computer-program product of claim 10, wherein the one or more reference signals are contiguous.

13. A method for wireless communication, comprising:
receiving, on a subframe allocated to a serving Node B, a grant message for a downlink transmission in a subset of subframes allocated to one or more non-serving Node Bs; and
receiving a signal indicating one or more reference signals, to be received in the subset of the subframes, which are usable by a user equipment (UE).

14. The method of claim 13, further comprising performing Radio Resource Management (RRM) measurements on the subset of the subframes using the one or more reference signals.

15. The method of claim 13, further comprising performing channel estimation for demodulating and decoding downlink transmissions from the serving Node B on the subset of the subframes using the one or more reference signals.

16. The method of claim 13, wherein receiving the signal comprises receiving the signal through at least one of layer 3 signaling or layer 1 signaling.

17. The method of claim 13, wherein the one or more reference signals are contiguous.

18. An apparatus for wireless communication, comprising:
means for receiving, on a subframe allocated to a serving Node B, a grant message for a downlink transmission in a subset of subframes allocated to one or more non-serving Node Bs; and
means for receiving a signal indicating one or more reference signals, to be received in the subset of the subframes, which are usable by a user equipment (UE).

19. The apparatus of claim 18, further comprising means for performing Radio Resource Management (RRM) measurements on the subset of the subframes using the one or more reference signals.

20. The apparatus of claim 18, further comprising means for performing channel estimation for demodulating and decoding downlink transmissions from the serving Node B on the subset of the subframes using the one or more reference signals.

21. The apparatus of claim 18, wherein the means for receiving the signal comprises means for receiving the signal through at least one of layer 3 signaling or layer 1 signaling.

22. The apparatus of claim 18, wherein the one or more reference signals are contiguous.

23. An apparatus for wireless communication, comprising:
at least one processor configured to:
receive, on a subframe allocated to a serving Node B, a grant message for a downlink transmission in a subset of subframes allocated to one or more non-serving Node Bs; and
receive a signal indicating one or more reference signals, to be received in the subset of the subframes, which are usable by a user equipment (UE); and a memory coupled to the at least one processor.

24. The apparatus of claim 23, wherein the at least one processor is configured to perform Radio Resource Management (RRM) measurements on the subset of the subframes using the one or more reference signals.

25. The apparatus of claim 23, wherein the at least one processor is configured to perform channel estimation for demodulating and decoding downlink transmissions from the serving Node B on the subset of the subframes using the one or more reference signals.

26. The apparatus of claim 23, wherein the at least one processor configured to receive the signal comprises receiving the signal through at least one of layer 3 signaling or layer 1 signaling.

27. The apparatus of claim 23, wherein the one or more reference signals are contiguous.

28. A computer-program product for wireless communication, the computer-program product comprising:
a computer-readable medium having code for:
receiving, on a subframe allocated to a serving Node B, a grant message for a downlink transmission in a subset of subframes allocated to one or more non-serving Node Bs; and
receiving a signal indicating one or more reference signals, to be received in the subset of the subframes, which are usable by a user equipment (UE).

29. The computer-program product of claim 28, further comprising code for performing Radio Resource Management (RRM) measurements on the subset of the subframes using the one or more reference signals.

30. The computer-program product of claim 28, further comprising code for performing channel estimation for demodulating and decoding downlink transmissions from the serving Node B on the subset of the subframes using the one or more reference signals.

31. The computer-program product of claim 28, wherein the code for receiving the signal comprises code for receiving the signal through at least one of layer 3 signaling or layer 1 signaling.

32. The computer-program product of claim 28, wherein the one or more reference signals are contiguous.
